(19) United States
(12) Patent Application Publication
(10) Pub. No.: US 2026/0063390 A1
(43) Pub. Date: Mar. 5, 2026

(54) OPTICAL CHANNEL COMMUNICATION FOR LASER RANGEFINDERS OR OTHER MOBILE OPTICAL DEVICES

(71) Applicant: LEUPOLD & STEVENS, INC., Beaverton, OR (US)

(72) Inventor: Dustin MILLER, Beaverton, OR (US)

(21) Appl. No.: 19/312,197

(22) Filed: Aug. 27, 2025

Related U.S. Application Data
(60) Provisional application No. 63/688,255, filed on Aug. 28, 2024.
(60) Provisional application No. 63/688,256, filed on Aug. 28, 2024.

(51) Int. Cl. F41G 3/06; F41G 3/08; H04B 10/112

(52) U.S. Cl. CPC F41G 3/06; F41G 3/08; H04B 10/112

(57) ABSTRACT

Various embodiments described herein may include a laser rangefinder or another mobile optical device, the laser rangefinder or the other mobile optical device including: an integrated display, or an external interface to couple to another display; a line-of-sight communication interface capable of communication with a remote system when at least one optical receiver of the line-of-sight communication interface has line of sight to a light-transmission module of the remote system; processing circuity to, in response to the at least one optical receiver capturing light transmitted over-the-air from the light-transmission module: recover one or more values bases on the captured light; and present the one or more values, or information derived therefrom, using the integrated display, or transmit a signal representing the recovered one or more values, or the information derived therefrom, over the external interface. Other embodiments may be disclosed and/or claimed.

### PRIORITY

This non-provisional patent application claims benefit of U.S. Provisional Application 63/688,255, filed on Aug. 28, 2024 and entitled OPTICAL COMMUNICATION FOR LASER RANGEFINDERS OR OTHER MOBILE DEVICES, and U.S. Provisional Application 63/688,256, filed on Aug. 28, 2024 and entitled RANGEFINDING INCLUDING BALLISTIC METERING, each of which are incorporated by reference herein

### TECHNICAL FIELD

The field of the present disclosure relates generally to mobile optical devices (e.g., laser rangefinders), and more particularly to optical channel communication there between.

### BACKGROUND

In order to collect the precise measurements needed to calculate ballistics for determining bullet drop, a shooter may need to live shoot through a chronograph to determine initial bullet speed exiting a firearm. The chronograph may operate based on some form of light curtain based technology, or may use radar placed close to the muzzle of the firearm to capture bullet speeds.

Many shooters do not own a chronograph, so they may be forced to travel to a shop or gun range that has one to buy time on the machine. Alternatively, the shooter may use the muzzle velocities printed on the side of the ammunition boxes as an estimate even though actual velocities vary depending on the firearm being shot and many other factors.

Another input for ballistics calculation is Ballistic Coefficient (BC) or Drag Coefficient (C_{d}). Either can be determined experimentally and may be related by the mass and cross sectional area of the bullet. These are coefficients in the ballistic calculations used to account for drag on a bullet flying through air. Today, a BC or C_{d} may be provided by a bullet manufacturer based upon their experimental lab data using advanced radar based systems. Many times however, this data is not available on the box of ammunition, or in lookup tables online, because the data is expensive to generate.

Some companies, such as bullet manufacturers, may offer ballistics calculators that operate based on a linked database. However, the capability of these ballistics calculators may depend on the breadth of the data in linked bullet database. Depending on the ballistics calculator used (one example is 4DOF™ from Hornady®), a bullet manufacturer/provider may provide their bullet database but not of their competitor bullet manufacturers. This may become a pain point for a shooter, because the linked database may not be complete for some of the ammunition the shooter may prefer to shoot, or may need to shoot due to ammunition availability.

### SUMMARY OF VARIOUS EMBODIMENTS

In one embodiment, a system may include a laser rangefinder or other mobile range finding system used to calculate a distance to a target, as well as sensor(s) for determining one or more of air temperature, pressure, humidity, sensor(s) for determining the time of flight of a bullet between rifle to target, and a processing unit such as a central processing unit (CPU). The processing unit may receive these inputs, and calculate: muzzle velocity, Drag Coefficient (C_{d}), Ballistic Coefficient (BC), Time of Flight, and/or other outputs found in various ballistic calculators.

In one embodiment, various components such as atmospheric sensors, a microphone, and a CPU are all combined within a housing of a laser rangefinder. The laser rangefinder may be arranged to capture each of the inputs, perform the calculations onboard, and then provide the calculations into a ballistics program in a “learning mode”. Thereafter, the laser rangefinder may then range new targets and calculate bullet drop and wind drift accurately by standard ballistics calculator methods.

Another embodiment may pair a laser rangefinder in communication with separate sensors external to the housing. In a specific example, atmospheric sensors may be onboard the laser rangefinder, however a microphone and CPU may be provided by a separate mobile device (such as a smartphone in Bluetooth® communication with the laser rangefinder). In these embodiments, the CPU on the smartphone may calculate the ballistics inputs onboard using an app.

In another embodiment, a laser rangefinder does not require atmospheric inputs, but is paired with a remote system including a sensor and communication device that is placed at the target(s). A sensor(s) on the laser rangefinder determines a trigger for the start timer of a shot. This may be a microphone-captured sound indicative of firing, an accelerometer for detecting recoil or muzzle blast, or an electronic sensor attached to the rifle. In other examples, this may be an optical sensor-captured image indicative of firing (e.g., a muzzle flash recorded by a light sensor at the target, and optically communicated back to an optical receiver associated with the laser rangefinder using an LED or other light-generating device pointed back at the shooter's position and laser rangefinder).

The bullet may be launched at the target where it eventually strikes the target. An impact sensor at the target may determine the bullet strike on the target, and may be paired with a light-generating device (e.g., an LED) pointed back at the shooter's position and laser rangefinder. This light-generating device may be in the same wavelength as the laser rangefinder (905 nm or 1550 nm typically). Since the laser rangefinder is highly tuned to these IR invisible frequencies, this received photonic signal travels back to the laser rangefinder virtually instantaneously with the speed of light, and represents a “stop” for the timer. All these may be used in combination to determine an accurate time start/stop for the flight of the bullet.

If the distance is sufficiently short, this bullet speed can be considered the initial velocity or muzzle velocity. If a user shoots at multiple distances, a speed vs distance curve can be then be determined experimentally. This curve may show the deceleration of the speed of that exact rifle/bullet combination as a function of distance. This deceleration is directly due to the atmospheric drag on the bullet, thus the drag coefficients and ballistic coefficients can be calculated. The curve can be interpolated and extrapolated easily using standard ballistic methods to alternatively determine initial muzzle velocity, and can be extrapolated to determine speed at greater distances.

An embodiment using optical communication from the target position may eliminate the need to use a microphone to listen for a sound of the target being hit (e.g., a ‘ding’). This embodiment may allow the bullet time-of-flight to be directly measured by the (Tₛₜₐᵣₜ) from the firing sound (e.g., a ‘boom’) and a (T_{end}) from the target light signaling back to the laser rangefinder (e.g., flashing or any other illumination). This may remove some error of atmospherics and wind, however may require the remote system, or another device, at the target to determine T_{end}.

### BRIEF DRAWINGS DESCRIPTION

The accompanying drawings, wherein like reference numerals represent like elements, are incorporated in and constitute a part of this specification and, together with the description, explain the advantages and principles of the presently disclosed technology.

FIG. 1 is a schematic diagram illustrating a system that may be used in range finding including ballistic metering, according to various embodiments.

FIG. 2 is a flow chart illustrating operations that may be performed by any system described herein.

FIG. 3 is a graph showing sound capture of a single shot event, according to various embodiments.

FIG. 4 is a graph showing a zoom-in on a single shot event, according to various embodiments.

FIG. 5 is a graph showing experimental data for multiple shots using different ammunition in the same firearm, according to various embodiments.

FIG. 6 is another graph showing experimental data for multiple shots using different ammunition in the same firearm, according to various embodiments.

FIGS. 7A and 7B are data tables corresponding to the group of FIG. 6.

FIG. 8 is another graph showing experimental data for multiple shots using different ammunition in the same firearm, according to various embodiments.

FIG. 9 is a graph showing a predicted endpoint window with respect to a sound capture of a single shot event, according to various embodiments.

FIG. 10 is a schematic diagram illustrating a system using optical channel communication in a wind metering application, according to various embodiments.

FIG. 11 is an example of a three-dimensional wind vector map that may be generated by the sensor data processing module of FIG. 10.

FIG. 12 is a schematic diagram illustrating a system with two laser rangefinders or other laser-capable mobile optical devices to optically communication via an over-the-air laser channel, according to various embodiments.

FIG. 13 is a graph showing an image of a sound file of a firing, which may be compared against a finger print of a particular rifle firing.

FIG. 14 is another graph showing an image of a sound file of a firing, which may be compared against a finger print of a particular rifle firing.

### DETAILED DESCRIPTION

With reference to the drawings, this section describes particular embodiments and their detailed construction and operation. Throughout the specification, reference to “one embodiment,” “an embodiment,” or “some embodiments” means that a particular described feature, structure, or characteristic may be included in at least one embodiment. Thus appearances of the phrases “in one embodiment,” “in an embodiment,” or “in some embodiments” in various places throughout this specification are not necessarily all referring to the same embodiment. Furthermore, the described features, structures, and characteristics may be combined in any suitable manner in one or more embodiments. In view of the disclosure herein, those skilled in the art will recognize that the various embodiments can be practiced without one or more of the specific details or with other methods, components, materials, or the like. In some instances, well-known structures, materials, or operations are not shown or not described in detail to avoid obscuring aspects of the embodiments.

Various known ballistic calculators, provided as an alternative to using a chronograph, may operate based on significant assumptions taken from lab data and/or simplified coefficients. These values may differ from experimental measurements of the exact bullet and gun being shot by a shooter.

By way of background, a bullet traveling down a barrel creates impressions on a bullet with the barrel's rifling. This is a unique fingerprint and what is used in forensic science to match bullets with guns of criminals. Being a unique fingerprint on the exterior of the bullet, this has impact on how a bullet experiences atmospheric drag as unique as the fingerprint itself, and is completely unique for each rifle and each bullet type.

Given the above, the only truly accurate way to have accurate ballistic inputs is for a shooter is directly measure their rifle and bullets that are shot from that rifle. However, the tools available today to make these measurements are not practical to take into the field.

Mobile range finding systems, such as laser rangefinders, may include electronics that allow the mobile range finding system to couple to a device having compute resources (such as a smartphone), and/or may include its own compute resources. These compute resources, whether internal to the mobile range finding system (hereinafter ‘local’ compute resources), accessible using an external interface of the mobile range finding system (hereinafter ‘remote’ compute resources), or including compute resources of more than one device (hereinafter ‘distributed’ compute devices), may be application-specific computing resources (e.g., an application specific circuitry, such as an ASIC) and/or general purpose computing resources (e.g., a general purpose circuitry, such as a general purpose processor to execute instructions stored on a memory). Any of these components or some other electronics may be utilized to perform any operations described herein.

Various embodiments described herein may include a range finding system to 1) determine precise distances to targets (e.g., using a portable range-finding device, such as a handheld laser rangefinder), as well as compute resources (whether local, remote, distributed, and/or application-specific or general purpose, etc.) to 2) calculate projectile flight times reflective of live ammunition fired at a target. The calculated bullet flight times may be used to determine one or more projectile characteristics, including projectile velocity (e.g., muzzle velocity), which may be specific to the individual firearm and ammunition used to hit the target.

In various embodiments, the system may utilize a variety of data to calculate the projectile flight times, such as:
Sensor data, which may be collected by internal and/or external sensors (which may be accessed via an external interface of the laser-rangefinder or other mobile range finding system). This sensor data may include atmospheric measurements, such as atmospheric temperature, pressure, humidity, or the like, in some embodiments; and/or
Data input by a user via a user interface in communication with the compute resources (e.g., via a user interface of the mobile range finding system and/or a smartphone or other portable device in communication with the mobile range finding system). The user-input data may include bullet mass (grains) and caliber (inches).

Using inputs such as the sensor data and/or the user inputs, the compute resources may determine any projectile characteristics, such as initial velocity (e.g., muzzle velocity), drag and deceleration of the bullet, drag coefficients, and ballistic coefficients, or the like, directly from live fire. These projectile characteristics may be displayed in the field in some embodiments, and/or stored on a memory for subsequent retrieval and display. Thus, the user may obtain projectile characteristics specific to the user's firearm and ammunition in the field, which may reduce/eliminate the need for a chronograph or lab ballistics system.

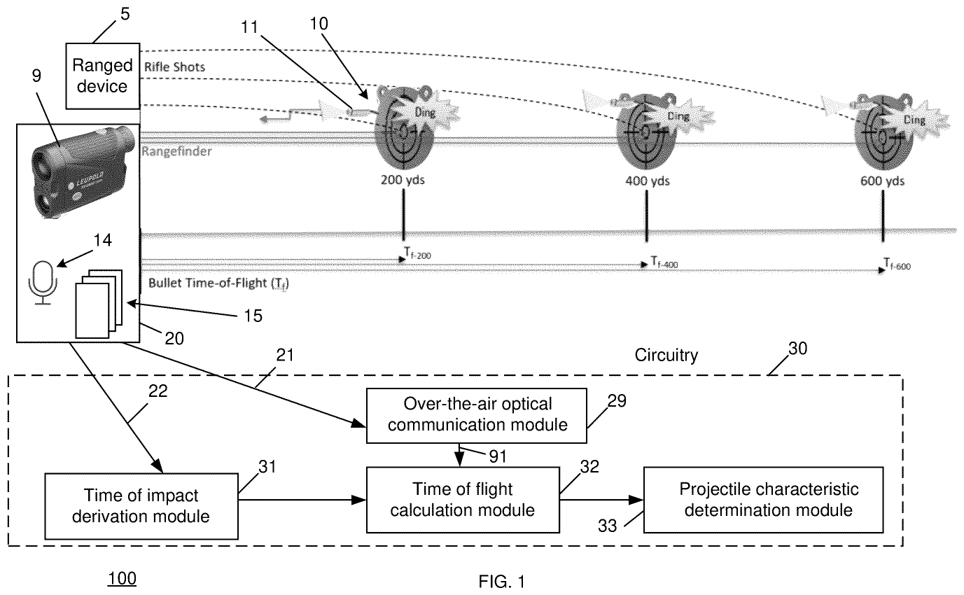

FIG. 1 is a schematic diagram illustrating a system 100 that may be used in range finding including ballistic metering, according to various embodiments. The system 100 may include a range determination system 20 and at least one impact determination system, such as one integrated into the system 20 or one or more remote impact determination system(s) 10. Any impact determination system may be utilized to 1) detect a time of impact of the projectile on the target(s), or to 2) derive a time of impact of the projectile on the target.

In the present example, which utilizes target-located sensors, remote impact determination system(s) 10 are provided at target location(s). Each target-located impact determination system 10 may include any impact sensor, now known or later developed, and a light-generating device 11 to optically communicate information collected by the input sensor back to the launch position, e.g., to an optical receiver associated with the system 20 and/or the circuitry 30. In one example, after a user fires at the target, the user may point the laser rangefinder 9 (or other device associated with an optical sensor) at the target to receive the optically-communicated transmission.

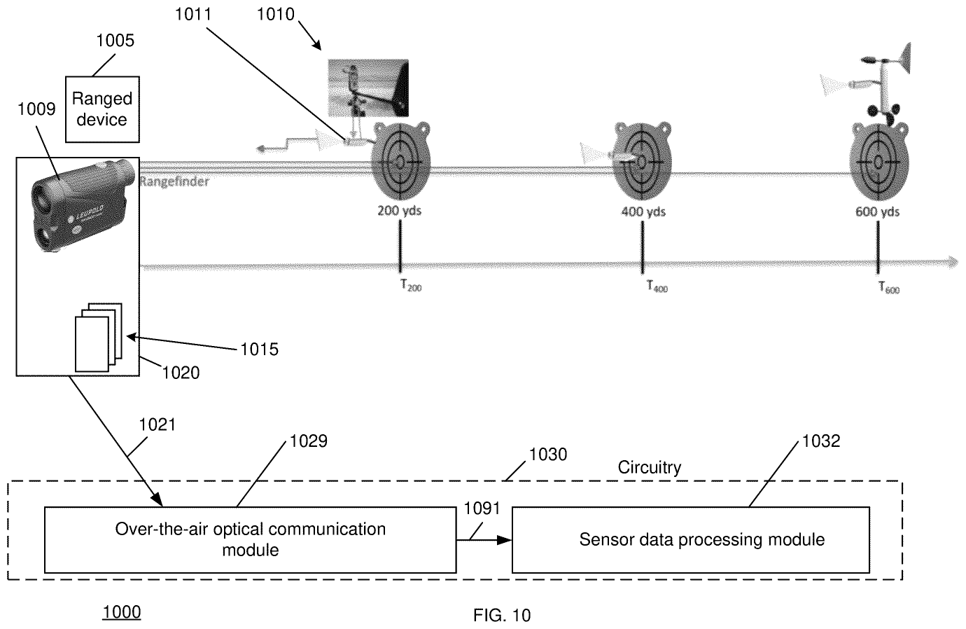

Then, any compute resource(s) of any device in the system 100 may operate an over-the-air optical communication module 29 to recover an output 21 of an optical receiver associated with laser rangefinder 9, e.g., to recover sensor data represented by the optically-communicated transmission. The over-the-air communication module 29 may be similar in any respect to over-the-air optical communication module 1029 (FIG. 10). In various embodiments, either the raw data, or data derived therefrom, may be part of a signal 91 transmitted to a time of flight calculation module 32.

Referring still to FIG. 1, in an example that does not require the target-located impact determination system(s) 10, an integrated or local impact determination system may include a microphone 14 at the launch position, and associated compute resource(s) in communication with the microphone 14 (e.g., compute resource(s) of the circuitry 30 to process sensor data 22 collected by the microphone 14). A module 31 may monitor for a sound having predetermined characteristics corresponding to a projectile-target impact. For example, the module 31 may monitor for one or more audio characteristics corresponding to the ‘ding’ that occurs when the projectile impacts the target. The module 31 may infer a time that the projectile impacted the target in part by calculating the amount of time required for sound to travel from the target back to the launch position based on current atmospheric conditions, in various embodiments.

Referring still to FIG. 1, the circuitry 30 is shown in dashed line to indicate that it may be part of a single mobile device, or may be distributed across more than one mobile device. For instance, the circuitry 30 may be distributed amongst the laser rangefinder 9 (or other mobile range finding system), and any device in communication therewith (such as a smartphone or other mobile device with compute resources, in communication with the laser rangefinder 9 or other mobile range finding system). Other device(s) housing at least a part of the circuitry 30 may be located at the launch position, or any other location. As mentioned earlier, at least some of the circuitry 30 may be local or remote, with respect to the laser rangefinder 9 or other mobile range finding system, and/or distributed amongst the laser rangefinder 9 and a smartphone or other compute device coupled to the laser rangefinder 9.

Referring still to FIG. 1, the ranged device 5 may be any ranged device, now known or later developed. Ranged device 5 need not be part of the impact determination system 20, as illustrated in FIG. 1. As such, any ranged device 5, including those without any electronics, can be used in the illustrated system. However, in other embodiments, a ranged device used to hit the target may include one or more sensors that are part of the system 20. For example, a ranged device may include an accelerometer that can be used to collect information used by compute resource(s) of the circuitry 30 to determine a time of launch of each projectile fired at the target(s). In various embodiments, a ranged device may include compute resource(s) that may derive one or more values from raw sensor data (put another way, at least part of the circuitry 30 may be located on a ranged device in some embodiments).

The microphone 14 may be any microphone, now known or later developed. It may be integrated into any mobile device described herein, such as integrated in the laser rangefinder 9 (or other mobile range finding system) or integrated in a smartphone or other mobile device in communication with the laser rangefinder 9. In other embodiments, a standalone microphone in communication with the laser rangefinder 9 (or other mobile range finding system) may be placed at the launch position.

The system 20 may include one or more additional device(s) 15, in addition to the microphone 14 and the laser rangefinder 9. As already mentioned, these additional device(s) 15 may include a smartphone or other mobile device, electronics of a ranged device, sensors, or the like. Sensors at the launch position may be integrated with the any device described herein, or may be standalone sensors. Standalone sensors may be capable of collecting raw data, and providing the raw data to any compute resource described herein. In other embodiments, a standalone sensor device may include compute resources of its own (as such, the circuitry 30 may be distributed across any mobile devices such as the laser rangefinder 9 and a standalone sensor device).

The circuitry 30 may include one or more modules, such as the illustrated modules, or any other module to perform any operation described herein. In embodiments including remote (e.g., target located) impact determinations systems 10 including impact sensors and light-generating devices, the time of impact derivation module 31 may be omitted. In these embodiments, a time of flight calculation module 32 may receive raw information collected by the impact sensors, or information derived therefrom. In embodiments without the remote impact determination system(s) 10, the module 31 may receive raw information collected by the microphone 14, or information derived therefrom. Operations performed by the module 31 may include any operations described herein, such as operations described in the section herein entitled “Time of Impact Derivation. ”

Referring again to module 32, it may receive, as an input, a detected time of impact or a derived time of impact for one of the target locations. Using this input, and information of a time of launch of the projectile provided by the system 20, the module 32 may calculate a time of flight of the projectile from the launch position to the corresponding target location. For example, the module 32 may determine a difference between the time of launch and the detected time of impact or the derived time of impact, to determine the time of flight associate with that target location. This process may be repeated to determine times of flights corresponding with each of the target locations, respectively. The module 33 may then determine one or more projectile characteristics from the calculated time(s) of flight.

As mentioned earlier herein, in some embodiments light may be used to determine the time of projectile launch. This may be an optical sensor-captured image indicative of firing, e.g., a muzzle flash recorded by a light sensor (not shown) at the target, and optically communicated back to an optical receiver associated with the laser rangefinder using a light generating device (e.g., an LED) pointed back at the shooter's position and laser rangefinder. In some embodiments, the light generating device pointed back at the shooter's position may be one of the light-generating devices 11, and this light-generating device may be used to optically communicate an optical sensor-captured image indicative of firing, or data derived therefrom, back to an optical receiver at the shooter's position (such as back to the laser rangefinder 9).

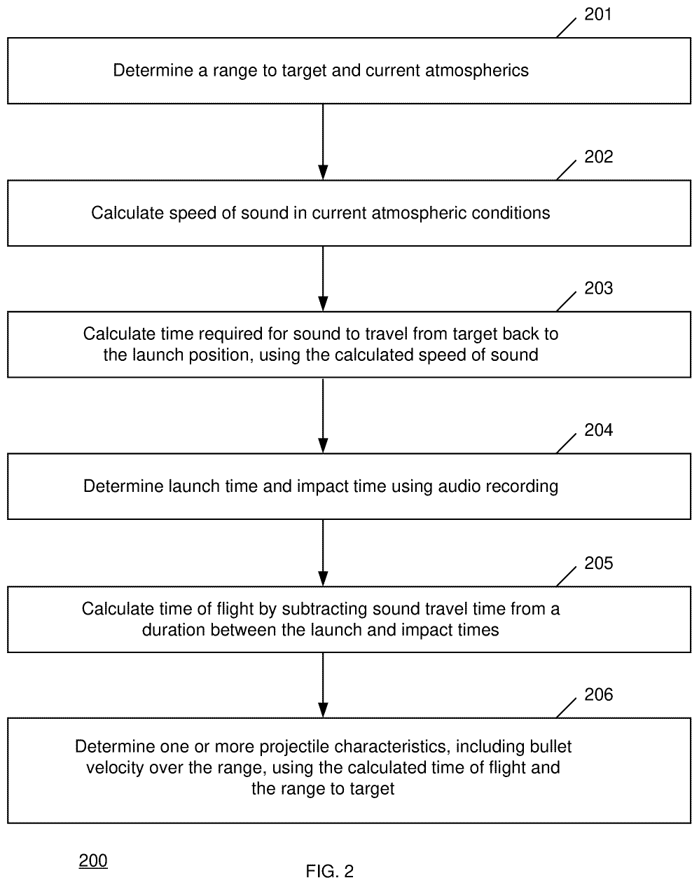

FIG. 2 is a flow chart illustrating operations 200 that may be performed by any system described herein. In block 201, any system described herein (e.g., one including a mobile range finding system capable of range finding) may determine a range to target and current atmospherics (using, with respect to the mobile range finding system, local or remote atmospheric sensors).

In block 202, the system (e.g., any module and/or circuitry described herein) may calculate the speed of sound in the current atmospheric conditions. In block 203, the system (e.g., any circuitry described herein) may calculate the time required for sound to travel from the target back to the launch position, using the calculated speed of sound.

In block 204, the system (e.g., any module and/or circuitry described herein) may determine launch and impact times using an audio recording (which may be captured using, with respect to the range finding device, a local or remote microphone). In block 205, the system (e.g., any module and/or circuitry described herein) may calculate time of flight by subtracting the calculated sound travel time from a duration between the launch and impact times. In block 206, the system (e.g., any module and/or circuitry described herein) may determine one or more projectile characteristics, including bullet velocity over the range, using the calculated time of flight and the range to target.

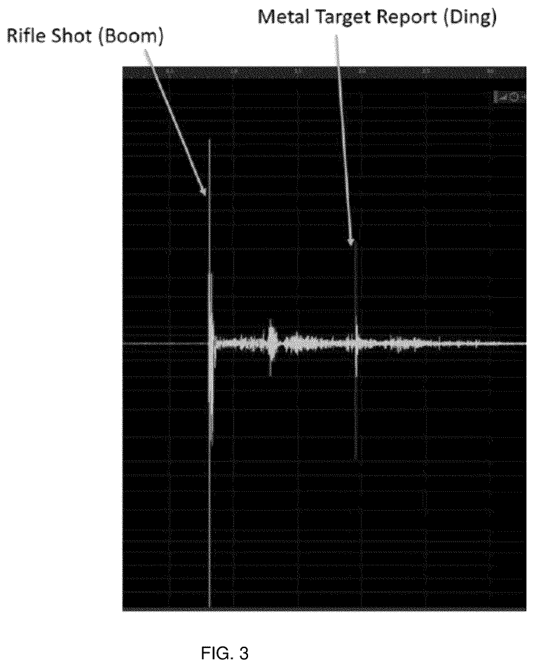

FIGS. 3-8 illustrate graphs corresponding to one specific example system including a range finding device and one or more computing devices to operate software to perform soundwave analysis and timing (e.g., a smartphone and a laptop in one example), to derive time of impact of the projectile on the target. The system may perform the following operations in the order shown (although the described order may not be required in other examples):
1. A system including a range finding device having onboard sensors and CPU is provided. The range finding device may be put into a ballistics reporting mode, e.g., “Ballistics Teach Mode,” in one example.
2. The system may use the range finding device to determine a range to a target (ex. 297 yards).
3. The system may use the onboard sensors of the range finding device to measure atmospherics from sensors (ex. Temperature=68 F, Pressure=27.56 inHg, Relative Humidity=41%).
4. The system may use the range finding device's CPU to then calculate the speed of sound in those atmospheric conditions (1128.3 ft/sec).
5. The system may use the range finding device's CPU to calculate the time required for sound to travel from target back to the range finding device (Sound Time-of-Flight (ST_{f})) based on the measured distance (297 yards×3 ft/yard/1128.3 ft/sec=0.78968 seconds).
6. The system may use the range finding device's microphone to monitor for (e.g., ‘listen’ for) the firing sound (e.g., the boom of the rifle) and the target impact sound (e.g., the “ding” of a bullet hitting a metal target). In one example, a sound recording having a 50,000 Hz sampling rate may be used.
7. A shooter then fires a bullet at the target.
8. The system may then use the CPU of the range finding device to determine the (Tₛₜₐᵣₜ) from the firing sound and a (T_{end}) from the target impact sound. The CPU may calculate the bullet Time-of-Flight (T_{f}) by subtracting the sound time-of-flight (ST_{f}) from the total time based upon (Tₛₜₐᵣₜ) and (T_{end}).=1.151 s−0.78968 s=0.3613 seconds. This time of flight value indicates how long the bullet took to travel 297 yards.
9. The system may then use the CPU to calculate the average bullet velocity over that distance (297 yards×3 ft/yard/0.3613 seconds=2466 ft/sec).

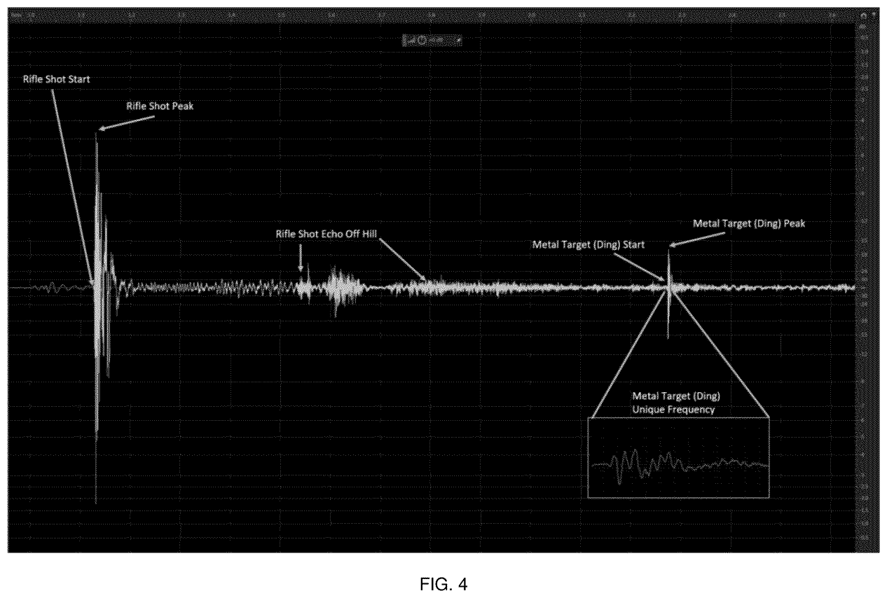

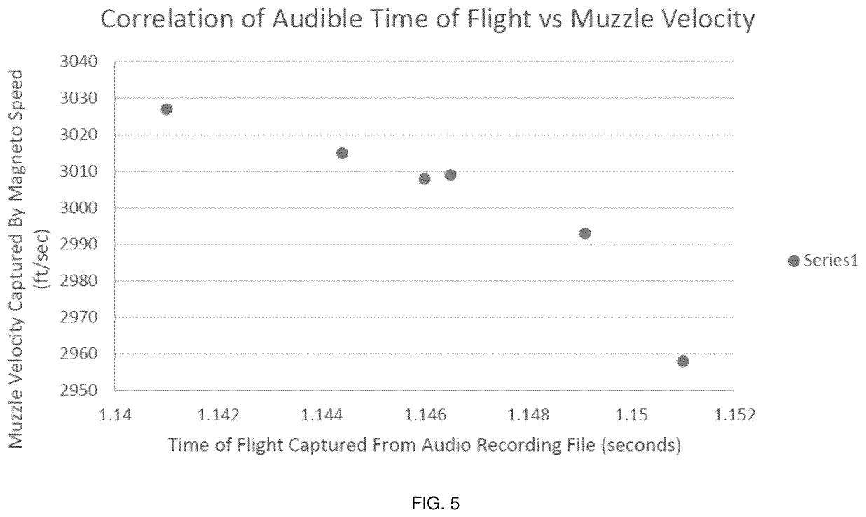

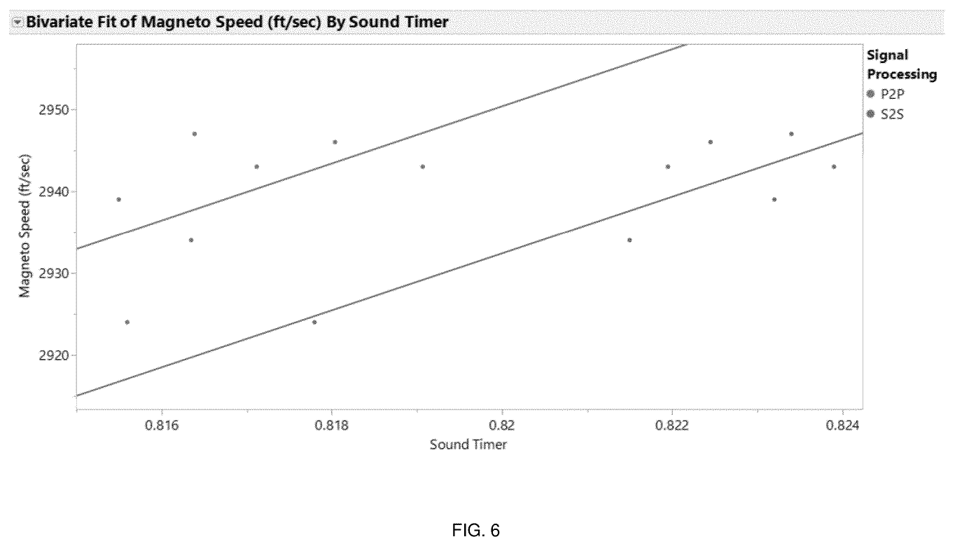

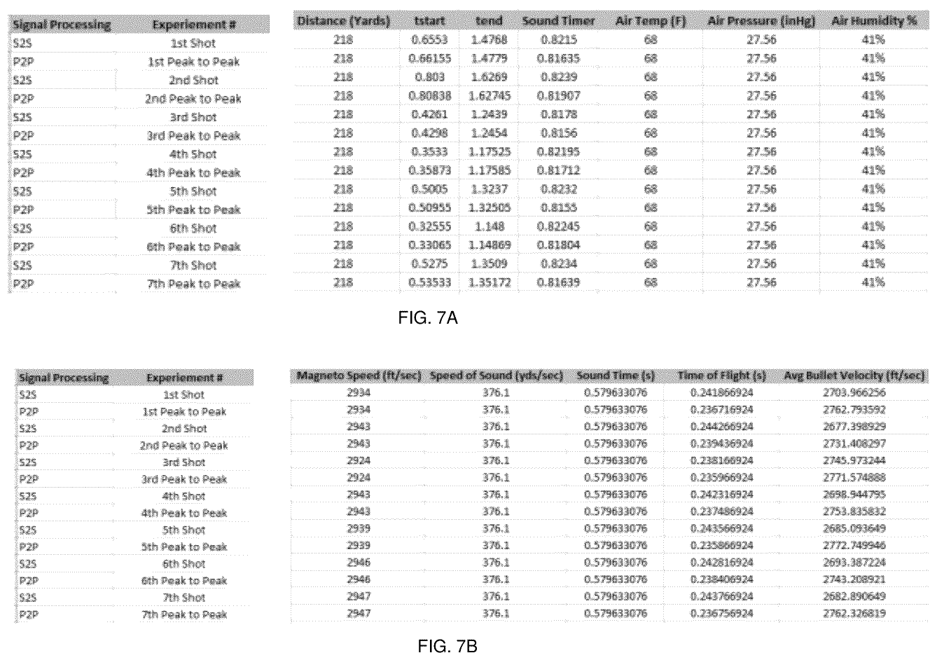

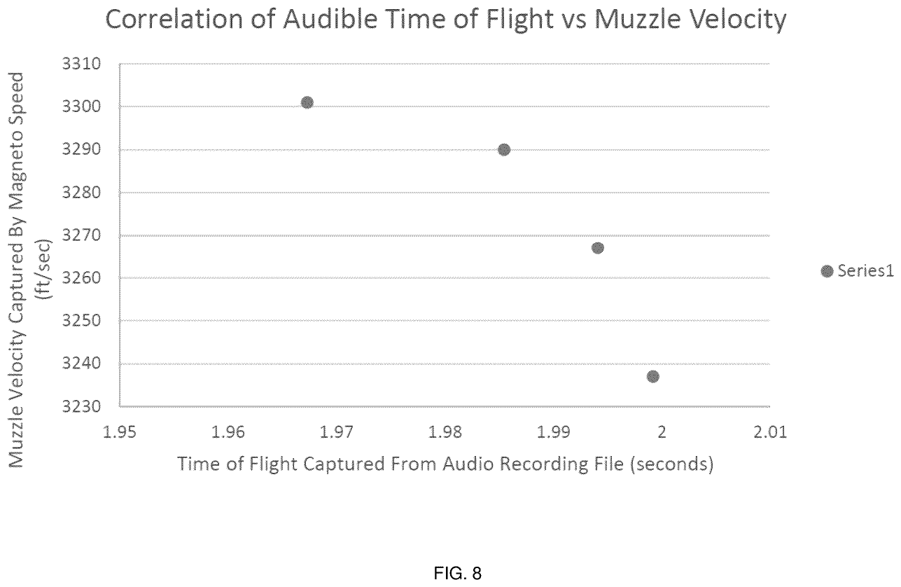

Operation 6 from the above, in particular, can be understood in more detail with reference to FIGS. 3-8, in which:
FIG. 3 illustrates a system-generated graph showing sound capture of a single shot event.
FIG. 4 illustrates a system-generated zoom-in on the single shot event, showing various sections of a captured sound file.
FIG. 5 illustrates a graph showing experimental data for multiple shots using different ammunition in the same firearm, at 297 yards. This graph plots correlation of audible time of flight vs. muzzle velocity.
FIG. 6 illustrates experimental data for multiple shots using different ammunition in the same firearm, at 218 yards. This shows the relationship between sound capture and chronograph at rifle muzzle. In this graph, data has been grouped by and compared by either start or peak sound wave.
FIGS. 7A-B are data tables corresponding to the graph of FIG. 6.
FIG. 8 illustrates a graph showing experimental data for multiple shots using different ammunition in the same firearm, at 503 yards. This graph plots correlation of audible time of flight vs. muzzle velocity.

Some embodiments may utilize a sound processing algorithm to reduce error and improve accuracy in identifying firing times and/or impact times from captured audio. In one algorithm, the firing times and impact times may be correlated to the start of the sound signals illustrated in FIGS. 3 and 4. In another algorithm, firing and impact times may be correlated to peak values in the sound amplitude. In testing, both algorithms had acceptable correlation to the actual muzzle velocities, even though they were offset from each other. In various embodiments, other sound processing algorithms may be used to determine when to start and stop a recording/timer.

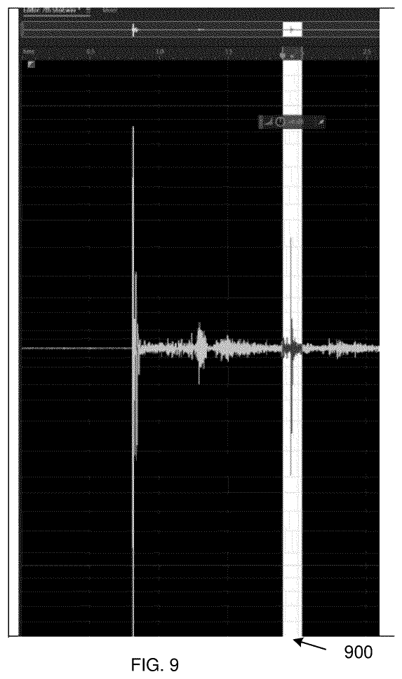

An error reduction feature may include initially calculating an endpoint window for the target impact sound. This could help in noisy environments or if others are shooting at the same target. This endpoint window could be calculated from an estimate of the muzzle velocity. Estimates are generally given on boxes of ammo, or can be provided by caliber or lookup table. A user could also just select a binary selection if they are shooting “normal supersonic” or “subsonic” bullets. As an example, a .223 caliber rifle generally shoots around 3000 ft/sec at the muzzle. An example window 900 is also shown in FIG. 9.

In one example of an endpoint window calculation, the following predicted values may be determined:
Bullet Flight Time=297 yards×3 ft/yard/3000 fps=0.3 sec
Sound Flight Back=297 yards×3 ft/yard/1128 fps (sound speed)=0.79 sec
Sum of both (0.3+0.79)=1.09 sec

The sum indicates the time for the system to start listening for the report even though the bullet does not maintain that speed (its decelerating).

To determine the end time for the endpoint window, a predetermined duration of time (e.g., 150 milliseconds, in this example) may be added to the start time. The predetermined duration of time may be selected from a plurality of predetermined error values based on projectile and/or firearm characteristics, distance to the target, or the like. With the start and stop times determined, in this example the system may start looking for the peak after 1.09 sec, up until a default error length duration (150 milliseconds in this example). The endpoint window would then be from (1.09-1.24 sec).

In other example, the predetermined error value may be a percentage, rather than a duration of time. The percentage could be scaled for distance. Actual bullet/sound flight times were 1.15 seconds. That would put the search within the window 900 in FIG. 9. In other examples, the predicted window could be tighter than the illustrated window 900, by using algorithms that take more inputs such as basic data on bullet deceleration, input speed and BC from the ammunition box, questions on sub-sonic ammunition or not, etc.

In some embodiments, a window determination algorithm may be used by any component described herein, or some other component, to identify the window. This algorithm may be based on the following inputs: 1) a published projectile velocity or a previously determined projectile velocity, 2) distance measured by a mobile range finding system, and 3) sound travel time (e.g., assumed or determined using sensors). The algorithm may add 1) projectile travel time to the target and 2) sound travel time back to the launch position, and then may modify this sum by a preset or variable+/−tolerance window from, say, 0-50% of that calculated time, to provide the beginning and end times for signal monitoring by the system.

Referring again to FIG. 1, the laser rangefinder 9 includes a viewable optical channel. However, this is not required. Some laser rangefinders without a viewable optical channel may be mounted to an optic sight (e.g., a scope) or other part of a firearm assembly (e.g., the ranged device 5 may include a scope in which a user may utilize the viewable optical channel of the scope to aim the mounted laser rangefinder). Any features described herein may be used with a laser rangefinder including a viewable optical channel or a laser rangefinder usable with a viewable optical channel of an optical device associated therewith.

Any component and/or system described herein may record time of flight on more than one shot/launch in which at least some of the shots/launches are at different distances, to generate a dataset. This dataset may be integrated into a velocity curve, declaration/drag curve, calculated drag coefficient, and/or calculated ballistic coefficients.

### Fingerprinting Firing/launching Signature and/or Target Impact Signature

Any component or system described herein may generate a signature of the sound produced at firing/launch of a particular ranged device and/or a signature of the sound produced by the projectile impacting a particular target. This may be particularly useful to allow a user to utilize any feature described herein in a noisy environment, such as a shooting range where there may be a variety of different firing/launching sounds and a variety of target impact sounds. In one example, the component or system may listen to launch conditions (e.g., the boom of a rifle), and teach an algorithm the spectral signature to fingerprint the firing/launching sound. Similarly, the component or system may listen to impact signature, to additionally teach the algorithm the spectral signature to fingerprint the target impact sound. This may allow a user to utilize any features described

One of ordinary skill in the part will recognize that any component or system described herein may utilize the fingerprint(s) in combination with any window described herein. In the noisy environment (e.g., the shooting range), the window may essentially act as a first stage of sound filtering (e.g., noises before or after the window may be filtered). The fingerprint(s) then may be used to pick out, say, firing/launching sound corresponding to the user from firing/launching sounds corresponding to other users (and/or target impact sound corresponding to the user from target impact sounds corresponding to other users).

### Analyzing Sensor Readings to Derive Time of Launch or Other Values

Any system described herein may include a user interface (e.g., a graphical user interface with various controls, or another user interface) to give the user the ability to record and store a firearm sound profile (e.g., a rifle sound profile). For instance, the user may be given the ability to fingerprint firing characteristics of their rifle at the start of a session, with various sensor components (e.g., a microphone, a barometer, etc.) placed at a particular location. A captured unique sound or air pressure changes can be used to recognize the user's rifle firing at, say a firing range, where there a lot of firing sounds or air pressure changes that could be captured by the system. This would allow a user to essentially filter out sounds or pressure changes by other rifles at a range (only triggering the start timer based on detecting firing by the user's rifle).

In some embodiments, the use of fingerprinting as described above may depend on the various sensor components having a constant location/position during the firing session. However, this may not be required, for instance it may be possible for any processor described herein to track a position or orientation of the sensor components (using, say, using an accelerometer), and to compensate a raw sensor reading based on position or orientation changes before determining the compensated sensor reading has a threshold similarity to the firing sound/pressure fingerprint.

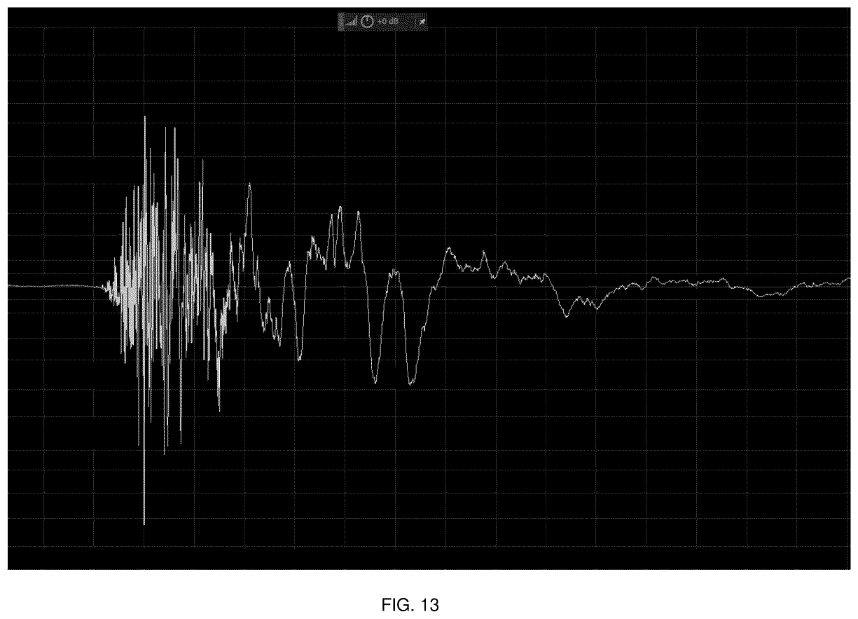

Another potential when analyzing the sound readings may include determining initial bullet speed (or muzzle velocity as typically called) using the decay of the initial sound wave. It may be possible to calculate speed based upon either the Doppler shift of the supersonic bullet “crack” as it is flying away and the sound is reported back to the microphone. Or this is more simply the reflection of the sound off the environment of the bullet supersonic crack. FIG. 13 includes an image of the sound file of the shot below illustrates both the unique fingerprint of the rifle, while also showing the initial sound spike and decay of sound.

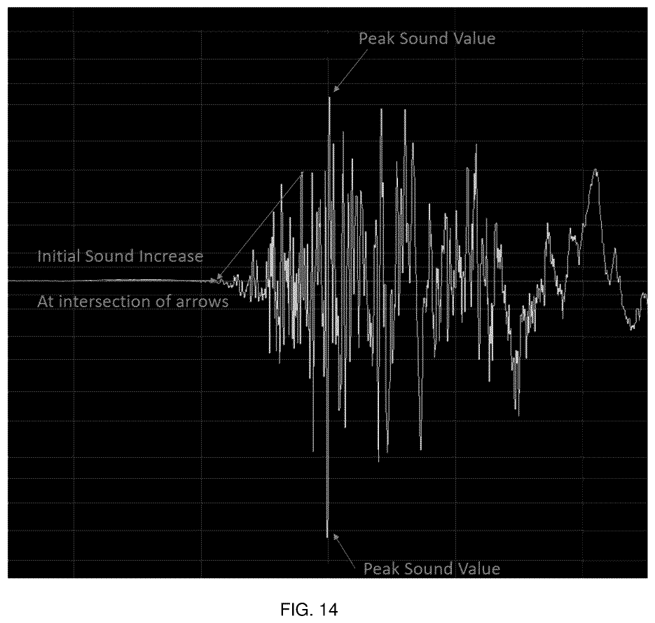

In various embodiments, the system may find the time of each event using both beak sound pressure level (the loudest portion of the spike). This may be referred to as the peak to peak time between rifle firing and target report. FIG. 14 indicates a first ramp up of sound, prior to a peak value.

There may be a baseline noise level (e.g., background noise), so the system may identify the initial climb by the intersection of the baseline and the climb of sound. This is illustrated in FIG. 14. In various embodiments, this could also be achieved by smoothing the sound wave and taking the derivative to determine time stamps of the rate of change of the slope.

### Optical Channel Communication for Laser Rangefinders or other Mobile Optical Devices

Some known laser rangefinders may communicate via a short range wireless interface, such as a Bluetooth transceiver. However, this type of transceiver, as well as other transceivers that use other radio wave technology such as WiFi® transceivers, may have a limited range of communication capability. For instance, the limited range of a Bluetooth transceiver may be ten meters, or less.

In various shooting applications, a shooter may setup a wind metering device at their shooting position, in order to determine a windage adjustment to utilize on a sighting device of a rifle or other ranged device. Known wind meters may also use short range wireless interfaces, such as a Bluetooth transceiver.

When a shooting application involves shooting across long ranges, such as a thousand years or thousands of yards, wind conditions at other locations along the whole range may vary significantly as compared to window conditions at the shooting location. To account for wind conditions across the whole range, it may be desirable to locate a wind meter at a location other than the shooter's location and/or to use additional wind meters. For instance, it may be desirable to locate one or more wind meters in the field, remote from the shooter's location, in order to determine more accurate windage adjustments.

If it is undesirable to hardware the connections for the remote wind sensors for any reason, it may be possible to form an array of wind meters to wirelessly communicate with each other step by step back to the shooter's location. However, the array of wind meters wirelessly communicating step by step back to the shooter's location may be undesirable for a number of reasons such as reliability, distance requirements for the wind meter to function correctly, etc.

In some shooting applications, multiple sensors may communicate in a “mesh” to send information back to shooter's location. However, this may require a very directional Bluetooth or WiFi signal to increase the overall signal, also may require mesh nodes to be less than about 50 yards from each other. For shooting applications involving shots at 1000 yards or more, at least twenty wind meter units may be needed to communicate back to the shooter's location. The expense and/or time to reliably setup a mesh of at least twenty wind meter units (or more) may be prohibitive.

Various embodiments described herein may use an over-the-air optical channel (such as a laser channel above the infrared band, e.g., in the range of 800-1750 nm, e.g., 905 nm or 1550 nm wavelength) to communicate, wirelessly, between two optical devices, such as a laser rangefinder at a projectile launch location and an LED or other light source coupled to a remote sensor, such as a wind sensor. The optical device at the projectile launch location, such as the laser rangefinder, may be configured (e.g., programmed) to use a communication algorithm to send and/or receive data packets over this laser channel. In some embodiments, the over-the-air optical channel may be at 1260-1675 nm, which may be desirable for utilizing existing equipment and materials to sense.

In one embodiment of wind metering, one or more target locations remote from the projectile launch location may each have wind meters paired with a light source (e.g., a 905 nm LED) pointed back at the projectile launch location. The target-located remote system(s) may be placed at distances as far as light will travel maintaining line-of-sight with a laser rangefinder or other mobile optical device at the projectile launch location.

Wind metering may be performed with each remote system(s), and each remote system may also transmit wind direction and speed information back to the projectile launch location via light transmission. In one embodiment, this transmitted information may be continually broadcast via light transmission so that real-time sensor information may be provided back to the projectile launch location.

Light transmission by the remote system(s) may not be required to be in a laser form, but can be omnidirectional so as not to require specific transmission alignment directionally. A user at the projectile launch location may point their laser rangefinder's optical channel toward any one(s) of these remote systems and receive the information of wind speed and direction. The user may sequentially point their laser rangefinder's optical channel toward each remote system saving the data from each.

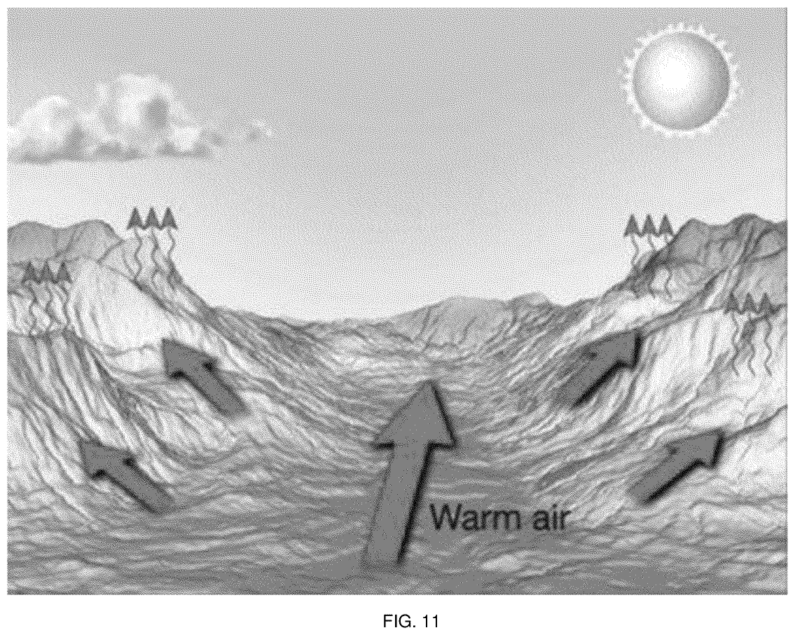

Once the sensor information is recovered by the laser rangefinder or other mobile optical device, one or more devices at the projectile launch location may precisely determine the position of each remote system relative to the shooter's location, and add this information to a model for generating a display for the user. In various embodiments, the one or more devices may place each wind meter on a map, such as a topographical three-dimensional map. Reading each wind meter and combining their positions, the one or more devices may then provide the user with a three-dimensional wind direction and speed map (e.g., a three-dimensional wind vector map) similar to that shown in FIG. 11.

In some embodiments, the one or more devices at the projectile launch location may include a laser rangefinder (or other mobile optical device) including a compass, inclinometer, a positioning system receiver (e.g., a Global Position System or other Global Navigation Satellite System receiver), and compute resources. The compute resources may be part of the mobile optical device and/or part of a mobile computing device (such as a smartphone) coupled thereto via a radio-based wireless connection (e.g., via a Bluetooth connection or another short range wireless connection), or a wire.

In some embodiments, using the wind vector map, a complete wind drift model can be constructed for the projectile flight path in any shooting/launching direction. This complete drift model may be a composite of all the wind drifts along the path the projectile may travel, and may be extremely accurate compared to the known systems that utilize wind metering at the shooter's position.

Additionally, in various embodiments, all this wind information may be passed to another user via a Bluetooth connection, via smartphone app text/email/etc., or be optimally communicated to an additional mobile optical device by sending data packets via a laser channel. The additional mobile optical device may know its geolocation (e.g., GNSS position) relative to the original mobile optical device, so a new vector map of the wind may then be calculated for the position of the additional mobile optical device.

This mobile optical device to mobile optical device communication may be used to send any type of information between mobile optical devices. In various embodiments, anything from firmware updates to private messages could be sent at extremely high bandwidths similar in any respect to fiber optics (though, over air, without the fiber). In one example, one of the mobile optical devices may determine the position of a game animal, then send that position data to other mobile optical device(s) via the laser channel (e.g., 905 nm or 1550 nm), so the user(s) of the other mobile optical device(s) could know the position of the game animal.

Mobile optical device communication between units may work well when both units are pointed at each other, though the receiver may need to know that information is available to be sent. This may pose a challenge in that other information may need to signal a data transfer request. To overcome this challenge, in some embodiments, an optical mobile device of a first user may be equipped with an additional optical receiver (e.g., an omnidirectional receiver) that may detect if a second user was “painting” them with a laser. The second user may need to just point their mobile optical device at the first user, and send a few quick pulses to flag the first user of a data connection request. The omnidirectional receiver on the first user's mobile optical device may receive that request and alert the first user of the request, and may also determine the direction of the incoming laser. The first user looking, through their mobile optical device, may utilize displayed arrows to guide them to pointing their main receive channel toward the second user and start data transfer handshake. Alternatively, the omnidirectional receiver on top of the mobile optical device may also be used to receive data if needed.

Sending data via laser light may provide some advantages for sending private messages. The signal may be virtually impossible to intercept unless the interceptor is in direct line with the laser. Either that interceptor would be seen, or send/receive confirmation signals between the rangefinders or other mobile optical devices may detect the obstruction and cease transfer. This has significant advantages if a user wants to send private messages to another user. Besides military applications (that may benefit from the possibility of covert communications), there are also civilian applications, such as where hunting in mountains that do not receive cellular signal, and thus communication may be significantly reduced to only two-way radio. Radio of course may be easy to intercept, and generally never private/covert like the optical communication described herein.

FIG. 10 is a schematic diagram illustrating a system 1000 using optical channel communication in a wind metering application, according to various embodiments.

The system 1000 may include a range determination system 1020 and one or more remote wind metering systems 1010. Each target-located system 1010 may include any wind metering sensor, now known or later developed, and a light-generating device 1011 similar in any respect to the light-generating device 11 (FIG. 1), or any other light-generating device described herein. The remote wind metering system(s) 1010 may be utilized to determine wind direction and speed information at the remote location(s), and transmit that information back to the range determination system 1020.

Referring still to FIG. 10, the circuitry 1030 may be similar in any respect to circuitry 30 (FIG. 1). The circuitry 1030 is shown in dashed line to indicate that it may be part of a single mobile device, or may be distributed across more than one mobile device. For instance, the circuitry 1030 may be distributed amongst the laser rangefinder 1009 or other mobile optical device and any device in communication therewith (such as a smartphone or other mobile optical device with compute resources, in communication with the laser rangefinder 1009 or other mobile optical device). Other device(s) housing at least a part of the circuitry 1030 may be located at the launch position, or any other location. As mentioned earlier, at least some of the circuitry 1030 may be local or remote, with respect to the laser rangefinder 1009 or other mobile optical device, and/or distributed amongst more than one device. Ranged device 1005 may be similar in any respect to ranged device 5 (FIG. 1), or any other ranged device described herein.

The range determination system 1020 may include one or more additional device(s) 1015, in addition to the laser rangefinder 1009 or other mobile optical device. As already mentioned, these additional device(s) 1015 may include a smartphone or other mobile device, electronics of a ranged device, sensors, or the like. Sensors at the launch position may include a wind metering sensor identical to the wind metering sensors of the remote system(s) 1010. Sensors at the launch position may be integrated with any device described herein, or may be standalone sensors. Standalone sensors may be capable of collecting raw data, and providing the raw data to any compute resource described herein. In other embodiments, a standalone sensor device may include compute resources of its own (as such, the circuitry 1030 may be distributed across mobile device(s) and a standalone sensor device).

The circuitry 1030 may include one or more modules, such as the illustrated modules 1029 and 1032, or any other module to perform any operation described herein. The module 1029 may recover an output 1021 of an optical receiver of the laser rangefinder 1009, e.g., to recover sensor data represented by the optically-communicated transmission, such as wind measurements collected by remote system(s) 1010.

In various embodiments, module 1029 may use techniques, now known or later developed, to send and/or receive data packets to and/or from a remote mobile optical device (not shown) similar in any respects to the laser rangefinder 1009, or any other mobile range finding system described herein. These data packets may contain any kind of data, including but not limited to: raw sensor data (or data derived therefrom), user input data in the case of user-to-user communications, control data for any application utilizing more than one mobile optical device (now known or later developed, such as known laser device applications that may currently use radio technology), or the like.

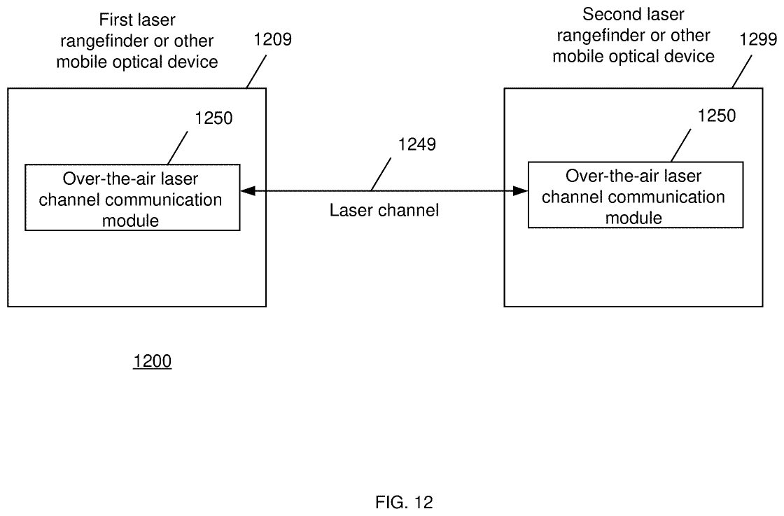

FIG. 12 is a schematic diagram illustrating a system 1200 with two laser rangefinders 1209 and 1299 (or other laser-capable mobile optical devices) to optically communication via an over-the-air laser channel 1249, according to various embodiments. The laser rangefinders 1209 and 1299 may include any laser beam transmitter or laser beam receiver, now known or later developed, such as a laser range finding transmitter/receiver. The modules 1250 may be similar in any respect to modules 29 (FIG. 1) and 1029 (FIG. 10).

In various embodiments, data optically communicated between mobile optical devices may be transmitted over the air using light in any form, such as in the form of a laser (e.g., in a laser channel), as in system 1200. However, referring again to FIGS. 1 and 10, the optical communication from the light-generated devices 11 and 1011, respectively, may be transmitted in in any form (e.g., without using a laser channel, in some examples). Data transmitted over the laser channel may be sensor data, data derived from sensor data, control data, user data, or the like.

It should be understood that the various range finder system and mobile optical device features described herein may be combined. For instance, a laser rangefinder may include any of the modules illustrated in FIG. 1 and/or any of the module illustrated in FIG. 10, which may allow a user to use the same device to perform one or more of: ballistic metering either with impact sensors or without, windage determination, rangefinder-to-rangefinder communications of sensor and/or user data, or the like.

Similarly, any target-located system described herein may combine the features described with reference to FIGS. 1 and 10. For instance, one target-located system may include a wind measurement sensor and an impact sensor, and a light-generating device to send sensor data back to a projectile launch location.

Some examples of mobile optical devices that may perform any of the operations described herein are laser rangefinders, range-finding monoculars, range-finding binoculars, a spotting scope, or any other device with range finding capabilities. However, some of the operations described herein may also be performed by any mobile optical device.

### Optical Channel Communication Using a Main Directional Receiver of a Rangefinder

In some applications, it may not be practical to provide an additional receiver (e.g., the previously described omni-directional receiver). In these applications, it may be possible provide similar functionality using the main directional receiver of a rangefinder or another mobile device.

In these embodiments, a main directional receiver could receive incoming light and determine the intensity by angular orientation to the incoming light. For various rangefinders, the light is in the invisible spectrum (e.g., 905 nm) where the user cannot see it, so the rangefinder may determine a direction by recording the intensity as a function of compass, inclination, gyro sensors, or the like, or combinations thereof. The rangefinder, once pointed in the general direction may start receiving grazing angles of light of lower intensity (say, as a user blindly initially scanned).

The rangefinder may then display to the user that it had picked up a signal, and may present instructions to the user to move the rangefinder or other mobile device up/down/left/right until the rangefinder or other mobile device detects a threshold light intensity (e.g., maximum light intensity when the main directional receiver is pointed directly at the signaling device). In various embodiments, the presented instructions may take the form of arrows on a display of the rangefinder or other mobile device (to coach a user into pointing the main directional receiver in an optimal position to capture the invisible light).

It may be possible and practical to initial transmit in a form other than a laser, until the user has pointed the main directional receiver at the signaling device. With the components aligned, a next light transmission may be in the form of a laser. Such an approach may also be used in a system in which the laser rangefinder or other mobile optical device includes plural optical receivers (such as the previously described example with a main directional receiver and an additional omni-directional receiver). In such an example, the light in the non-laser form may be captured by the omni-directional receiver whereas the light in the form of the laser may be captured by the main directional receiver).

### Enabling User Coalignment of Sensors to Ready for Transmission

In any embodiment described herein, a mobile rangefinding system may include sensor(s) for inclination and azimuth. These sensor(s) may record sensor data when signaled by a remote system (e.g., signaled using any optical communication channel described herein). The laser rangefinder may record distance to the remote system to determine a three-dimensional position from the laser rangefinder position.

In some embodiments, using the three-dimensional position, the mobile rangefinding system may guide a user visually via a display associated with a laser rangefinder to point the receiving sensor of the mobile rangefinding system in the direction of the remote sensor.

### EXAMPLES

Example 1 is an apparatus including electronics to perform one or more operations to determine one or more projectile characteristics, including at least projectile velocity of a projectile launched to a target, using collected optical information or collected audio information, the apparatus comprising: a sensor system coupled to the electronics, the sensor system to generate ranging data and additional data comprising sensor data; wherein the ranging data is indicative of range to the target from a launch position, wherein the sensor system comprises a laser rangefinder or another mobile range finding device, and a portion of the collected optical information is collected using an optical receiver associated with the laser rangefinder or the other mobile range finding device; and one or more additional sensors to identify a time of launch of the projectile, the one or more additional sensors including at least 1) a microphone to collect a portion of the audio information, to identify a time of impact of the projectile on the target, or 2) an impact sensor coupled to an LED or another light near the target, the LED or the other light to produce a portion of the optical information to indicate the time of impact, the produced portion based on a signal generated by the impact sensor; the one or more operations to calculate projectile time of flight using the time of launch and the time of impact, wherein the one or more projectile characteristics are determined, based at least in part on, the calculated projectile time of flight.

Example 2 includes the subject matter of example 1 or any other example herein, wherein the laser rangefinder or the other mobile range finding device comprises a range-finding monocular, a range-finding binocular, or a spotting scope.

Example 3 includes the subject matter of any of examples 1-2 or any other example herein, wherein the produced portion of the optical information is collected from a viewable optic channel associated with the optical receiver.

Example 4 includes the subject matter of any of examples 1-3 or any other example herein, wherein the produced portion of the optical information is transmitted in a wavelength range optimized for transmission over the viewable optic channel.

Example 5 includes the subject matter of any of examples 1-4 or any other example herein, wherein the time of launch of the projectile is determined from: an audio recording by the microphone or another microphone in communication with the electronics; accelerometer data collected an accelerometer in communication with the electronics, the accelerometer data indicative of recoil or muzzle blast; or optical signaling captured using the optical receiver or another optical receiver, wherein the optical signaling originates from the LED or the other light, and includes, or is derived from, an optical sensor-captured image indicative of firing produced by a light sensor near the target position.

Example 6 includes the subject matter of any of examples 1-5 or any other example herein, wherein the time of launch of the projectile is determined from data output by an electronic device, wherein the electronic device is integrated into a firearm to fire the projectile, integrated into the laser rangefinder, or integrated into the other mobile range finding device.

Example 7 includes the subject matter of any of examples 1-6 or any other example herein, the one or more operations further to: calculate sound travel time based on the sensor data, wherein the calculated sound travel time comprises an amount of time required for sound to travel from the target to the launch position based on local atmospheric conditions indicated by the sensor data; wherein the calculated projectile time of flight is determined using the calculated sound travel time and information indicative of: atmospheric temperature, atmospheric pressure, or humidity.

Example 8 includes the subject matter of any of examples 1-7 or any other example herein, further comprising a smartphone or other portable electronic device having one or more processors, the smartphone or the other portable electronic device coupled wirelessly, or via a wire, to the laser rangefinder or the other mobile range finding device, wherein the electronics includes at least one processor of the one or more processors.

Example 9 includes the subject matter of any of examples 1-8 or any other example herein, the one or more operations further to: calculate sound travel time based on the sensor data, wherein the calculated sound travel time comprises an amount of time required for sound to travel from the target to the launch position based on local atmospheric conditions indicated by a portion of the sensor data that is attributable to a sensor of the sensor system; wherein the sensor is part of the smartphone or the other portable electronic device; wherein the calculated projectile time of flight is determined using the calculated sound travel time.

Example 10 includes the subject matter of any of examples 1-9 or any other example herein, the one or more operations further to: search, utilizing at least an impact sound signature and a window, for audio indicative of the impact of the projectile on the target; wherein the utilization of the window filters a portion of sound occurring in an environment; and wherein the utilization of the impact sound signature filters an additional portion of the sound occurring in the environment.

Example 11 includes the subject matter of any of examples 1-10 or any other example herein, the one or more operations further to: determine whether the projectile is a subsonic projectile, or not, based on a user input or a user setting; and select a sound processing algorithm of a plurality of different sound processing algorithms in response to the subsonic projectile determination; and utilize the selected sound processing algorithm to determine the time of impact.

Example 12 includes the subject matter of any of examples 1-11 or any other example herein, wherein the one or more projectile characteristics are determined using one or more user inputs indicating at least one characteristic of the projectile; wherein the at least one characteristic includes bullet mass and caliber.

Example 13 includes the subject matter of any of examples 1-12 or any other example herein, wherein the one or more projectile characteristics further include muzzle velocity, drag coefficient, or ballistic coefficient.

Example 14 includes the subject matter of any of examples 1-13 or any other example herein, wherein the LED or the other light operates in a wavelength range of 800-1750 nm.

Example 15 includes the subject matter of any of examples 1-14 or any other example herein, the one or more operations further to: predict an endpoint window using published projectile characteristics, and scan for an audio signal indicative of the time of impact based at least in part on the predicted endpoint window.

Example 16 includes the subject matter of any of examples 1-15 or any other example herein, wherein the electronics include a memory to store the calculated time of flight; and the one or more operations further to, for a next projectile launched subsequent to the launch of the projectile, determine one or more projectile characteristics corresponding to the next projectile using the stored time of flight.

Example 17 includes the subject matter of any of examples 1-16 or any other example herein, wherein the one or more additional sensors include at least one sensor comprising an accelerometer, an air pressure sensor, a light sensor, a pressure pad sensor, a chronograph sensor or another radar sensor, or the microphone; and wherein the time of launch is determined using said at least one sensor.

Example 18 includes the subject matter of any of examples 1-17 or any other example herein, wherein the one or more additional sensors include a barometric sensor for reading air pressure; the one or more operations further to derive the time of launch based a reading from the barometric sensor, wherein the reading corresponds to an air pressure wave produced by launching the projectile.

Example 19 includes the subject matter of any of examples 1-18 or any other example herein, wherein: the microphone is used to determine both the time of launch and time of impact, or the microphone is used to determine the time of launch and the impact sensor is used determine the time of impact.

Example 20 includes the subject matter of any of examples 1-19 or any other example herein, the one or more operations further to fingerprint a sound associated with firing or air pressure changes associated with firing a particular firearm at said launch location at a start of a firing session, and store one or more values characterizing the fingerprinted sound or fingerprinted air pressure changes; wherein after the fingerprinting the sound or the air pressure changes, subsequently captured sounds or subsequently captured air pressure changes are filtered using the stored one or more values, including detect which subsequently captured sounds or subsequently captured air pressure changes of plural firing sounds or plural air pressure changes have a threshold coincidence with the stored one or more values; wherein the time of launch is determined using a particular one of the captured sounds or captured air pressure changes that has the threshold coincidence with the stored one or more values.

Example 21 is an apparatus, comprising: a laser rangefinder or another mobile optical device, the laser rangefinder or the other mobile optical device including: an integrated display, or an external interface to couple to another display; a line-of-sight communication interface capable of communication with a remote system when at least one optical receiver of the line-of-sight communication interface has line of sight to a light-transmission module of the remote system; processing circuity to, in response to the at least one optical receiver capturing light transmitted over-the-air from the light-transmission module: recover one or more values bases on the captured light; and present the one or more values, or information derived therefrom, using the integrated display, or transmit a signal representing the recovered one or more values, or the information derived therefrom, over the external interface to allow presentation of the recovered one or more values, or the information derived therefrom, on the other display.

Example 22 includes the subject matter of example 21 or any other example herein, wherein the laser rangefinder or the other mobile optical device comprises a range-finding monocular, a range-finding binocular, or a spotting scope.

Example 23 includes the subject matter of examples 21-22 or any other example herein, the processing circuitry further to: record distance to the remote system, wherein the distance is determined using the laser rangefinder or the other mobile optical device; and determine a three-dimensional position based, at least in part on, the recorded distance.

Example 24 includes the subject matter of examples 21-23 or any other example herein, the processing circuitry further to, using the determined three-dimensional position, visually guide a user of the laser rangefinder or the other optical device to point an optical receiver of the at least one optical receiver in a direction of the light-transmission module.

Example 25 includes the subject matter of examples 21-24 or any other example herein, wherein the recovered one or more values comprise: raw sensor data from a remote wind meter, a remote ballistic meter, or a remote hit sensor, or information derived from the raw sensor data.

Example 26 includes the subject matter of examples 21-25 or any other example herein, wherein the recovered one or more values comprise, or are derived from, raw sensor data generated by one or more sensors; wherein the one or more sensors are part of the laser rangefinder or the other mobile optical device, or are coupled to the laser rangefinder or the other mobile optical device via the external interface, the processing circuitry to combine the recovered one or more values, or the data derived therefrom, and the sensor data, or data derived therefrom, to generate a model representing a geographic region of interest over which the one or more sensors are placed or distributed.

Example 27 includes the subject matter of examples 21-26 or any other example herein, wherein the laser rangefinder or the other mobile optical device includes one or more radio interfaces having one or more maximum ranges, respectively; wherein the light-transmission module is a distance away from the laser rangefinder or the other mobile optical device, the distance exceeding the one or more maximum ranges.

Example 28 includes the subject matter of examples 21-27 or any other example herein, wherein the remote system comprises a plurality of wind sensors distributed across a geographic region of interest; and wherein the recovered one or more values comprise sensor data collected by at least one wind sensor of the plurality of wind sensors.

Example 29 includes the subject matter of examples 21-28 or any other example herein, the processing circuitry further to generate a wind vector map based at least in part on the recovered one or more values.

Example 30 includes the subject matter of examples 21-29 or any other example herein, wherein the other display is part of a smartphone or another mobile device coupled to the laser rangefinder or the other mobile optical device via the external interface.

Example 31 includes the subject matter of examples 21-30 or any other example herein, wherein the at least one optical receiver comprises a plurality of optical receivers including an omnidirectional optical receiver and an additional optical receiver; wherein the captured light transmitted over-the-air by from the remote system is captured by the additional optical receiver and the processing circuitry is further to: prior to capturing the light, capture other light via the omnidirectional optical receiver; and using the integrated display or the external interface, present a user instruction to aid the user in aligning the additional optical receiver with a beam produced by light-transmission module of the remote system.

Example 32 includes the subject matter of examples 21-31 or any other example herein, wherein the remote system includes: one or more LEDs, or some other light-generating part(s), and processing circuitry to process the one or more values, and control the one or more LEDs or the other light-generating part(s) based on a result thereof.

Example 33 includes the subject matter of examples 21-32 or any other example herein, wherein the at least one optical receiver comprises a directional receiver; the processing circuity to determine an intensity of the captured light by angular orientation.

Example 34 includes the subject matter of examples 21-33 or any other example herein, wherein the laser rangefinder or the other mobile device further comprises: a compass, an inclination sensor, or a gyroscope; the processing circuitry to recording an intensity of incoming light as a function of information from the compass, the inclination sensor, or the gyroscope.

Example 35 includes the subject matter of examples 21-32 or any other example herein, the processor circuitry further to: present, on the integrated display or the other display: an indication of an exception, the exception associated with the captured light having intensity below a threshold; and instructions for the person to orient or position the directional receiver to capture additional light at a greater intensity than the intensity.

Example 36 includes the subject matter of examples 21-35 or any other example herein, further comprising one or more LEDs or some other light-generating part(s) coupled to the at least one optical receiver or the processing circuitry: the processing circuitry further, in response to receipt of the light or in response to receipt of other light from the light-transmission module of the remote system, generate light using the one or more LEDs or the some other light-generating part(s), the generated light for transmission over-the-air to a remote laser rangefinder or another remote mobile optical device; wherein the generated light represents the recovered one or more values, or the generated light represents at least one value determined using the recovered one or more values.

Example 37 includes the subject matter of examples 21-36 or any other example herein, wherein the laser rangefinder or the other optical device bridges communications from the remote system to the remote laser rangefinder or the other mobile optical device, by using a light of sight to the light-transmission module and a line of sight to an optical receiver of the remote laser rangefinder or the other remote mobile optical device.

Example 38 is a system to communicate with one or more remote systems, wherein the one or more remote systems comprise one or more systems each of which is different than the system, the system comprising: a line-of-sight communication interface capable of communication with the one or more remote systems when at least one optical receiver of the system has line of sight to one or more light-transmission modules of the one or more remote systems, respectively; and processing circuity to, in response to the at least one optical receiver capturing light transmitted over-the-air by the one or more light-transmission modules, perform operations comprising: recover one or more values from the light; and display the recovered one or more values, or information derived therefrom, on an electronic display, or using one or more local LEDs or another light-generating device, transmit light representative of the one or more values, or representative of the information derived therefrom, to a remote laser rangefinder or another remote mobile optical device having processing circuitry to recover one or more values from the transmitted light.

Example 39 includes the subject matter of example 38 or any other example herein, wherein the system comprises a laser rangefinder or another mobile optical device configured to bridge communications a remote system of the one or more remote systems to the remote laser rangefinder or the other remote mobile optical device, by the transmission of the light representative of the one or more values, or representative of the information derived therefrom.

Example 40 includes the subject matter of examples 38-39 or any other example herein, wherein the system includes a sensor to determine a position of the remote laser rangefinder or the other remote mobile optical device; and the processing circuitry to generate a model based on the determined position and the recovered one or more values, wherein the information derived from the one or more values is determined using the model.

It should be understood that the subject matter of any of examples 21-40 may be combined with the subject matter of any of examples 1-20, or vice versa. Similarly, it should be understood that any of the features described in reference to any of FIGS. 10-12 may be combined with any of the features described in reference to any of FIGS. 1-9, 13, and 14.

It will be obvious to those having skill in the art that many changes may be made to the details of the above-described embodiments without departing from the underlying principles of the invention. The scope of the present invention should, therefore, be determined only by the following claims.

1. An apparatus, comprising:
a laser rangefinder or another mobile optical device, the laser rangefinder or the other mobile optical device including:
an integrated display, or an external interface to couple to another display;
a line-of-sight communication interface capable of communication with a remote system when at least one optical receiver of the line-of-sight communication interface has line of sight to a light-transmission module of the remote system;
processing circuity to, in response to the at least one optical receiver capturing light transmitted over-the-air from the light-transmission module:
recover one or more values bases on the captured light; and
present the one or more values, or information derived therefrom, using the integrated display, or transmit a signal representing the recovered one or more values, or the information derived therefrom, over the external interface to allow presentation of the recovered one or more values, or the information derived therefrom, on the other display.

2. The apparatus of claim 1, wherein the laser rangefinder or the other mobile optical device comprises a range-finding monocular, a range-finding binocular, or a spotting scope.

3. The apparatus of claim 1, the processing circuitry further to:
record distance to the remote system, wherein the distance is determined using the laser rangefinder or the other mobile optical device; and
determine a three-dimensional position based, at least in part on, the recorded distance.

4. The apparatus of claim 3, the processing circuitry further to, using the determined three-dimensional position, visually guide a user of the laser rangefinder or the other optical device to point an optical receiver of the at least one optical receiver in a direction of the light-transmission module.

5. The apparatus of claim 1, wherein the recovered one or more values comprise:
raw sensor data from a remote wind meter, a remote ballistic meter, or a remote hit sensor, or
information derived from the raw sensor data.

6. The apparatus of claim 1, wherein the recovered one or more values comprise, or are derived from, raw sensor data generated by one or more sensors;
wherein the one or more sensors are part of the laser rangefinder or the other mobile optical device, or are coupled to the laser rangefinder or the other mobile optical device via the external interface,
the processing circuitry to combine the recovered one or more values, or the data derived therefrom, and the sensor data, or data derived therefrom, to generate a model representing a geographic region of interest over which the one or more sensors are placed or distributed.

7. The apparatus of claim 1, wherein the laser rangefinder or the other mobile optical device includes one or more radio interfaces having one or more maximum ranges, respectively;
wherein the light-transmission module is a distance away from the laser rangefinder or the other mobile optical device, the distance exceeding the one or more maximum ranges.

8. The apparatus of claim 1, wherein the remote system comprises a plurality of wind sensors distributed across a geographic region of interest; and
wherein the recovered one or more values comprise sensor data collected by at least one wind sensor of the plurality of wind sensors.

9. The apparatus of claim 1, the processing circuitry further to generate a wind vector map based at least in part on the recovered one or more values.

10. The apparatus of claim 1, wherein the other display is part of a smartphone or another mobile device coupled to the laser rangefinder or the other mobile optical device via the external interface.

11. The apparatus of claim 1, wherein the at least one optical receiver comprises a plurality of optical receivers including an omnidirectional optical receiver and an additional optical receiver;
wherein the captured light transmitted over-the-air by from the remote system is captured by the additional optical receiver and the processing circuitry is further to:
prior to capturing the light, capture other light via the omnidirectional optical receiver; and
using the integrated display or the external interface, present a user instruction to aid the user in aligning the additional optical receiver with a beam produced by light-transmission module of the remote system.

12. The apparatus of claim 11, wherein the remote system includes:
one or more LEDs, or some other light-generating part(s), and
processing circuitry to process the one or more values, and control the one or more LEDs or the other light-generating part(s) based on a result thereof.

13. The apparatus of claim 1, wherein the at least one optical receiver comprises a directional receiver;
the processing circuity to determine an intensity of the captured light by angular orientation.

14. The apparatus of claim 13, wherein the laser rangefinder or the other mobile device further comprises:
a compass, an inclination sensor, or a gyroscope;
the processing circuitry to recording an intensity of incoming light as a function of information from the compass, the inclination sensor, or the gyroscope.

15. The apparatus of claim 14, the processor circuitry further to:
present, on the integrated display or the other display:
an indication of an exception, the exception associated with the captured light having intensity below a threshold; and
instructions for the person to orient or position the directional receiver to capture additional light at a greater intensity than the intensity.

16. The apparatus of claim 1, further comprising one or more LEDs or some other light-generating part(s) coupled to the at least one optical receiver or the processing circuitry:
the processing circuitry further, in response to receipt of the light or in response to receipt of other light from the light-transmission module of the remote system, generate light using the one or more LEDs or the some other light-generating part(s), the generated light for transmission over-the-air to a remote laser rangefinder or another remote mobile optical device;
wherein the generated light represents the recovered one or more values, or the generated light represents at least one value determined using the recovered one or more values.

17. The apparatus of claim 16, wherein the laser rangefinder or the other optical device bridges communications from the remote system to the remote laser rangefinder or the other mobile optical device, by using a light of sight to the light-transmission module and a line of sight to an optical receiver of the remote laser rangefinder or the other remote mobile optical device.

18. A system to communicate with one or more remote systems, wherein the one or more remote systems comprise one or more systems each of which is different than the system, the system comprising:
a line-of-sight communication interface capable of communication with the one or more remote systems when at least one optical receiver of the system has line of sight to one or more light-transmission modules of the one or more remote systems, respectively; and
processing circuity to, in response to the at least one optical receiver capturing light transmitted over-the-air by the one or more light-transmission modules, perform operations comprising:
recover one or more values from the light; and
display the recovered one or more values, or information derived therefrom, on an electronic display, or
using one or more local LEDs or another light-generating device, transmit light representative of the one or more values, or representative of the information derived therefrom, to a remote laser rangefinder or another remote mobile optical device having processing circuitry to recover one or more values from the transmitted light.

19. The system of claim 18, wherein the system comprises a laser rangefinder or another mobile optical device configured to bridge communications a remote system of the one or more remote systems to the remote laser rangefinder or the other remote mobile optical device, by the transmission of the light representative of the one or more values, or representative of the information derived therefrom.

20. The system of claim 19, wherein the system includes a sensor to determine a position of the remote laser rangefinder or the other remote mobile optical device; and
the processing circuitry to generate a model based on the determined position and the recovered one or more values, wherein the information derived from the one or more values is determined using the model.
